(19) United States
(12) Patent Application Publication
(10) Pub. No.: US 2016/0328142 A1
(43) Pub. Date: Nov. 10, 2016

(54) USER INTERFACE FOR MERGER AND DISPLAY OF MULTIPLE CONTENT TIMELINES AND METHOD THEREFOR

(71) Applicant: Yongjae LEE, Seoul (KR)

(72) Inventor: Yongjae LEE, Seoul (KR)

(21) Appl. No.: 14/905,963

(22) PCT Filed: Jul. 22, 2014
(86) PCT No.: PCT/KR2014/006621

§ 371 Date: Jul. 21, 2016

(30) Foreign Application Priority Data
Jul. 22, 2013 (KR) 10-2013-0085950

(51) Int. Cl. G06F 3/0488; G06Q 10/10; G06F 3/0354; G06F 3/0481; G06F 3/0482; G06F 3/0484

(52) U.S. Cl. CPC G06F 3/04883; G06F 3/0482; G06F 3/0484; G06F 3/03545; G06F 3/04817; G06Q 10/109

(57) ABSTRACT

Disclosed are a user interface and a method for providing various content timelines. A timeline user interface is provided for effective presentation of and intuitive access to various forms of timeline contents, where a timeline is merged, divided or searched for. The method for merging, dividing, and searching for a timeline, as well as a user interface comprising a touch gesture is also included.

### TECHNICAL FIELD

The present invention relates to a user interface and a method for providing various content timelines, and more particularly, to a user interface including a graphical user interface and a method which merges a plurality of timelines, recognizes a touch gesture, effectively provides time-based content, and allows a user to intuitively access the timelines.

### BACKGROUND ART

Today, together with the increased use of various devices—including computers and smart devices—, user data of various types and forms, as well as the sharing and transmission of such data are on the rise. In particular, a substantial portion of such user data is either shared communication contents—transmitted as in instant messaging, chatting, or social networks—or shared/published contents in the form of uploads or postings such as blogs. And the common characteristic for all of these content types is that the particular timing or the time order of such content is meaningful. For example, a “message” sent to or received from another participant (or another user; henceforth, “participant”) through a messenger application, such as text, voice, or photo, is by itself an independent “content”. However, the existence of any predefined context with a participant—as in a “chat window”—, any particular timing or the order gives more detailed meanings to such contents. In this manner, defining a scope of the various contents or data based on the context to designate a variety of conditions such as common purpose, subject, and participants; and presenting such content history in chronological order is called a “timeline”. Timelines are widely implemented and embodied as user interface through software on various devices such as computers, smart phones, and tablets. And, most of the user contents mentioned above as well as various other data shared or transmitted are presented through a “timeline”, which is embodied and concretized through its user interface and its operating method(s).

In fact, countless applications, a variety of services, computers, and devices are providing various kinds of data through “timelines”, and such data includes not only the user content as mentioned above but also the non-user content that are generated without any user's explicit engagement. For example, an event log generated by a server, or the deposit-withdrawal activity information in a bank account can be expressed and provided as a “timeline”. Indeed, the deposit-withdrawal history from any widely-used mobile banking app on mobile devices makes a great example. Therefore, along with today's increased use of various devices including computers and smart devices, “timelines” are indispensably used on various types and forms of user content and non-user data, as well as the sharing or transmission of such content or data. And, the “timeline” is an important form of user interface in realizing various functionalities such as instant messaging, social network service, and blogging application, and not to mention internet banking.

However, the conventional “timeline” exists within each application or program in the form of an individual “single/singular timeline”. This means that each “timeline of data” is individually embodied as a disparate and independent “timeline user interface”, which is simple and easy to build but causes many inconveniences to the user. For example, a “singular timeline” interface such as a “chatting room window” in an instant messenger keeps even similar contents separate and isolated across timelines, and such timelines can be each accessed only one at a time. Hence, it is highly inconvenient for a user having to jump back and forth between various contents dispersed across multiple timelines. Furthermore, it gets worse when there is an overlap between multiple timelines in chronological order or when there exists any similarity or close relationship between them such as the participants or the subject; it is highly inconvenient since neither any comprehensive at-a-glance overview (of such related timelines) nor any organic access to or use of such timeline contents is practically possible. In the above “messenger” scenario, for example, when the same participant (another user) joined and exists in multiple “chatting window” timelines, each of which is composed of different members, the conventional “singular timeline” user interface does not allow a user to organically navigate between these timelines that share a common factor, nor to view the contents together at a glance. So, even when trying to view or access related timelines, a user still has to look for, navigate, and jump back and forth between each timelines as if there existed nothing in common and as if these chatting windows were totally unrelated.

Simply put, even in case of browsing or accessing related contents, a user is forced to deal with the inconvenience of jumping back and forth between multiple timelines. For example, when a user was in a chat session with participants A, B, and C—in a conventional instant messenger—and if the user were to send a message or share/transmit data to only the participants A and B, but except C, the user then must create a new timeline by opening another chat window and invite participants A and B into a separate discussion. What's worse, if the first chat room window—including participant C—were to also continue simultaneously, the user has to jump back and forth between two different chat room windows—one with participants A, B, and C, and another with only A and B—just to keep up with reading and responding to the content. The same inconvenience applies to the other participants A and B as well. Further, for all of them (the user as well as other participants A and B), it will be very easy to confuse—about different timelines—which chat room window is which. In another example, there may be a case where a user simultaneously participates in two different messenger sessions with completely different participant members—one with participant C and D, and another with E, F, and G—and needs to compare information from these seemingly unrelated timelines. To determine the order of or to identify the time difference between when contents such as messages or photos were transmitted or shared across separate timelines, the user must review each timeline separately and compare time information individually. No intuitive “at-a-glance” display of contents through a single interface is possible with this conventional “singular” timeline.

To make matters worse, this isolated form of “conventional timeline” exponentially increases complexity as well as users' inconvenience as the composition of various participants or simultaneous transmission/sharing of data to multiple recipients increases, in addition to increased complexity due to sheer increase in content data. It makes it difficult for a user not only to intuitively understand various contents dispersed across many different timelines, but also to manage or maintain such content data. From a user's perspective, it may be practically impossible to get a comprehensive look or an organic understanding of relationships across timelines while using the conventional “singular” timelines: if and how any particular participant exhibited any change of opinion across timelines of various topics or different participant compositions, and whether there are any correlations to before-and-after certain activities; what kind of information was transmitted or shared to any particular participant in which timeline from a long-term perspective; or what other participants there were in such timelines. However, considering how commonly the majority of people simultaneously communicate with so many others on so many subjects and topics, and how frequently they access and acquire various information, the limitations of the user interface posed by the conventional “timeline”—as illustrated above—are the cause of a very significant inefficiency as well as inconvenience.

As seen above, many problems arise from the “singular timeline”—such as the inconvenience and inefficiencies due to dispersed contents, the redundant duplication of the same participants across multiple timelines, or the inability to organically browse and navigate multiple timelines that include any common participant. These problems may be resolved by somehow combining and “merging” a plurality of these “singular timelines” into a single unified timeline; however, the recurrently exists no concrete ways of embodying “the merging” of multiple timelines into one. Such merging of timelines also presents a new set of challenges. Additionally, there does not exist any easy-to-learn, intuitive user interface nor its operating method that's not confusing or complex. For example, trying to merge and present two different timelines—an instant messenger timeline with participant A, and another blog timeline with participant Z—, creates new problems of determining: how to request or command a merger of timelines; how to standardize different forms or features across timelines; how to mark and distinguish content objects or individual item (henceforth, “content object”) from different timelines; how to synchronize and reconcile time information between different timelines and to determine the order in the new merged timeline. All of these are new problems that didn't exist with the conventional “singular” timelines. Also, the easy and intuitive user interface as well as its operating method to embody all of these presents another set of new problems, which therefore this invention intends to address and solve.

### DISCLOSURE

### Technical Problem

Therefore, an object of the present invention is to provide technology which combines a plurality of timelines that are each provided as isolated or dispersed, singular timeline, into a single unified “merged” timeline to allow a user to intuitively comprehend and access such timeline(s) at a glance. The present invention also enables a plurality of timelines to be flexibly merged or divided based on the user's intent or use, irrespective of content of the timeline such as subject or participant, technical format of the timeline, or the varied purpose of each individual timeline.

To this end, the present invention defines and provides a “merged timeline” (or consolidated timeline; henceforth, “merged time line”) by merging a plurality of timelines, and allows the time order of the timeline's contents to be accurately recognized by reconciling and synchronizing standardized time data across various singular timelines—irrespective of their source, their purpose, or their form. Additionally, the present invention enables a user to intuitively distinguish “content item objects” that originate from different timelines by appropriately indicating or providing them. Also, the present invention enables to search or provide related timelines so that organic navigation and browsing can be made between individual timelines or content item objects. The present invention also provides a user interface and an intuitive method for requesting a merge or split of such merged timeline.

According to all the details described above, the present invention provides an easy-to-learn-and-use method for user to merge or split timelines, as well as an organic browsing method through search of related timelines. Additionally, the present invention provides technology for implementing an intuitive and efficient user interface and a method thereof.

### Technical Solution

In one general aspect, a method, performed on an apparatus which includes or is connected to a display device, includes: merging two or more “merge-target timelines” (timelines to merge) to generate a new “merged timeline”, wherein each of the “merge-target” timelines is a “singular” timeline or a separate “merged” timeline including one or more singular timelines, and the “singular” timeline includes zero “content item object” or one or more “content item objects”, time information for the one or more “content item objects”, and zero piece of participant information or one or more pieces of participant information; and displaying the new “merged” timeline on the display device, wherein the generating of the new merged timeline includes: dividing or converting all merged timelines, included in the merge-target timelines, into or to singular timelines; correcting or adjusting a reference time for all singular timelines included in the merge-target timelines; assigning a time order among each of content item objects included in the merge-target timelines; and assigning information about the corresponding singular timeline to each content item objects included in the merge-target timelines and combining them into a new timeline to generate the new merged timeline. The apparatus further includes a touch sensitive surface. The method further includes selecting the merge-target timelines to merge. Selecting the merge-target timelines includes: simultaneously displaying the two or more merge-able (merge-target) timelines on the display device; detecting one or more contacts, corresponding to positions of the merge-able (merge-target) timelines, from the touch sensitive surface; recognizing a selection gesture in response to the number of the detected contacts, a start position, a contact point movement, and an end position; and selecting a merge-target timeline in response to the recognition of the selection gesture.

According to an embodiment of the present invention, the content item object may include various transmission activity information—activity information about transmission, opening access, or sharing of various messages or content data.

According to another embodiment of the present invention, the content item object may include various posting information—information about posting or content of a webpage or a blog.

According to another embodiment of the present invention, the content item object may include text data.

According to another embodiment of the present invention, the content item object may include binary data—content in the form of audio, video, image, or file.

According to another embodiment of the present invention, the content item object may include streaming data.

According to another embodiment of the present invention, the recognition of the selection gesture may include, when the number of the detected contacts is one and there are timelines respectively corresponding to the start position and the end position according to the contact point being moved, recognizing the selection gesture to select the timelines as merge-target timelines.

According to another embodiment of the present invention, the recognition of the selection gesture may include, when the number of the detected contacts is two or more, there are timelines respectively corresponding to all contact start positions, and a distance between contact points is reduced according to the contact point being moved, recognizing the selection gesture to select the timelines as merge-target timelines.

According to another embodiment of the present invention, the touch sensitive surface may be a touch pad.

According to another embodiment of the present invention, the contact may be a finger contact.

According to another embodiment of the present invention, the contact may be a stylus contact.

In another general aspect, a graphical user interface in an apparatus, which includes or is connected to a display device, includes: a merged timeline area configured to provide a merged timeline in a designated region of the display device, wherein two or more merge-target timelines—a singular timeline or a separate merged timeline including one or more singular timeline—are merged to provide the merged timeline containing content item objects from the merge-target timelines, wherein providing the merged timeline includes: providing the content item objects contained in the merged timeline in the common merged timeline area according to a time order, and wherein the content item object comprises one or more of content data, transmission activity information, and posting information, and includes a designated timeline indication feature corresponding to the encompassing singular timeline including the content item object. The content item object further includes a participant icon, and the participant icon includes information related to a participant which has transmitted or posted a corresponding content item object. The merged timeline area further includes “activation/deactivation indication feature” of a timeline, the “activation/deactivation indication feature” indicates activation of one selected singular timeline or indicates deactivation of all other timelines, wherein the “activation/deactivation indication feature” is a shape, image, or color of the content item object. The designated region of the display device further includes “content input area”, and the “content input area” includes an element that inputs, transmits, or posts content to the active singular timeline. The “content input area” further includes an element that is changed according to a kind of the active singular timeline. The merged timeline area further includes “abbreviated timeline/object indicator”, and while the content item objects are being provided, the “abbreviated timeline/object indicator” instead of one or more content item objects corresponding to the singular timeline is displayed according to a setting of the apparatus.

According to an embodiment of the present invention, the timeline indication feature may include a shape, image, color, or icon of the content item object or a shape, image, color, or icon of a background of the content item object.

According to another embodiment of the present invention, the timeline indication feature may include a border between content item objects included in different singular timelines.

According to another embodiment of the present invention, the timeline indication feature may include a shape, image, color, or label of the participant icon.

According to another embodiment of the present invention, the timeline indication feature may include a position of the participant icon in the merged timeline area or an indicated connection of the participant icon.

According to another embodiment of the present invention, the timeline indication feature may include a shape, image, or color of the “abbreviated timeline/object indicator” or a shape, image, or color of the content item object.

According to another embodiment of the present invention, the timeline indication feature may include a border between content item objects included in different singular timelines, between “abbreviated timeline/object indicators” included in different singular timelines, or between the content item object and “abbreviated timeline/object indicator” included in different singular timelines.

In another general aspect, a method, performed on an apparatus which includes or is connected to a touch sensitive surface and a display device, includes: displaying a merged timeline, generated by merging two or more merge-target timelines, in a designated merged timeline area of the display device; and changing a state of the merged timeline, wherein the changing of the state includes: detecting one or more contacts, corresponding to a position in the merged timeline area, from the touch sensitive surface; recognizing a state change gesture in response to number of the detected contacts, a start position, a contact point movement, and an end position; and changing the merged timeline in response to the recognition of the state change gesture.

According to an embodiment of the present invention, the recognition of the state change gesture may include, when the number of the detected contacts is one and there is a content item object corresponding to the start position without the contact point being moved, selecting and activating a singular timeline which includes the content item object and deactivating all other timelines.

According to another embodiment of the present invention, the recognition of the state change gesture may include, when the number of the detected contacts is two or more and a distance between contact points increases according to the contact point being moved, closing the graphical user interface corresponding to the merged timeline, and navigating to a singular timeline which was previously selected and active.

In another general aspect, a method, performed on an apparatus which includes or is connected to a display device, includes: displaying one or more timelines on the display device, wherein each of the one or more timelines is a singular timeline or a merged timeline and includes zero content item object or one or more content item objects, time information of the one or more content item objects, and zero piece of participant information or one or more pieces of participant information; and searching for a related timeline associated with the one or more timelines, wherein the searching for the related timeline includes: selecting a criterion of searching for the related timeline; conducting a search for the related timeline; and displaying a result of the search for the related timeline. The apparatus further includes a touch sensitive surface. The selecting of the criterion includes: detecting one or more contacts, corresponding to positions of the one or more timelines, from the touch sensitive surface; recognizing a selection gesture in response to number of the detected contacts, a start position, a contact point movement, and an end position; and selecting the criterion of the search for the related timeline in response to the recognition of the selection gesture.

According to an embodiment of the present invention, the selecting of the criterion may include selecting the criterion, based on participant information included in the one or more timelines or participant information corresponding to a specific content item object included in the one or more timelines, and the conducting of the search for the related timeline may include searching for another timeline including the participant.

In another general aspect, a graphical user interface in an apparatus, which includes or is connected to a display device, includes: a timeline area configured to provide a timeline in a designated region of the display device, wherein the timeline is a singular timeline or a merged timeline, and the timeline provides one or more content item objects included in the timeline to the timeline area according to a time order using the apparatus, wherein the content item object includes one or more of content data, transmission activity information, and posting information, and the content item object displays zero participant icon or one or more participant icons.

According to an embodiment of the present invention, another timeline including a participant may be searched for by clicking on a corresponding participant icon or through a menu displayed by the click, wherein a result of the search may be provided as a related timeline.

### Advantageous Effects

According to a configuration of the present invention, various timeline data, including instant messenger, social network, or blogs—that offer a variety of content—as well as a variety of activity history, become consistently accessible and manageable, commonly in the form of “merged timeline” user interface. Particularly, as described above, a content included in various types of timelines is provided in a universal form called, “content item object”, and thus, a difference in format or any technical difference between each timeline as well as any difference in time information are corrected or reconciled during a merge operation, and an appropriate form and a time order are realized in a merged timeline. This includes not only the content types such as a messenger chat where two or more participants exchange contents; but also any uni-directional content types such as blogs or postings from a social network service.

Moreover, according to a configuration of the present invention, a user's comprehensive understanding may be facilitated through an at-a-glance view of a single user interface without the need for visiting back and forth multiple interface windows or screens—even when a plurality of timelines each include the same type of contents and the user needs to identify the order of such contents, or when the same user or participant is overlappingly engaged in multiple timelines and contents are dispersed and spread across a plurality of timelines.

Moreover, according to a configuration of the present invention, an intuitive gesture may be used to easily and flexibly access timeline contents to newly create, activate, deactivate, or split a “merged timeline”—on a variety of devices that are equipped with or connected to a touch-sensitive surface, such as smart phone, tablet, and computer.

Moreover, according to a configuration of the present invention, a “merged timeline” user interface provides various forms and methods for intuitively distinguishing and easily understanding the relationship between the “content item objects” within the merged timeline and the original singular timeline where the “content item objects” come from (henceforth, an “originated timeline”).

Moreover, according to a configuration of the present invention, a “merged timeline” user interface provides a method to indicate whether a timeline is in active (“activated”) or inactive (“deactivated”) state as to which timeline—among many included timelines within the merged timeline—user's content input is transmitted or posted to. This enables a user to easily and intuitively distinguish and identify which timeline is to receive content input, without any confusion. Additionally, depending on the type of active timeline, the “content input area” may be accordingly adjusted to receive content input appropriate per each timeline.

Moreover, according to a configuration of the present invention, a “merged timeline” user interface provides an “abbreviated timeline/object indicator” which collapse, compress, or skip contents of a particular timeline within a “merged timeline”. This enables a portion of various contents included in a “merged timeline” to be temporarily compressed or skipped to enhance readability.

Moreover, according to a configuration of the present invention, a “related timeline” corresponding to a “merged timeline” or a “singular timeline” may be searched for, and the search may be performed based on the participant information included in a corresponding timeline or a selection gesture. Another timeline in which a corresponding participant participates may be searched for and provided by using participant information or a participant icon of a user interface, or a criterion for search of related timelines may be set by using a selection gesture. Accordingly, a “related timeline search” function ultimately enables organic access to and navigation between various “singular” or “merged” timelines, as well as additional merging of more timelines.

### DESCRIPTION OF DRAWINGS

FIG. 1 is a diagram illustrating an example of changing to a merged timeline user interface according to an embodiment of the present invention.

FIGS. 2A and 2B are diagrams describing an example of timeline-merging gesture based on a mouse or a touch.

FIGS. 3A to 3C are diagrams illustrating an example of indication feature between singular timelines within a merged timeline, to distinguish and identify each individual singular timeline, according to an embodiment of the present invention.

FIG. 4 is a diagram illustrating an example of activation/deactivation indication feature in a merged timeline according to an embodiment of the present invention.

FIG. 5 is a diagram illustrating an example of an abbreviated timeline/object indicator according to an embodiment of the present invention.

FIGS. 6A and 6B are diagrams illustrating an example of an activation of a timeline and changing content input area based on a touch input, and an example of dividing or splitting a merged timeline using a gesture according to an embodiment of the present invention.

### MODE OF THE INVENTION

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

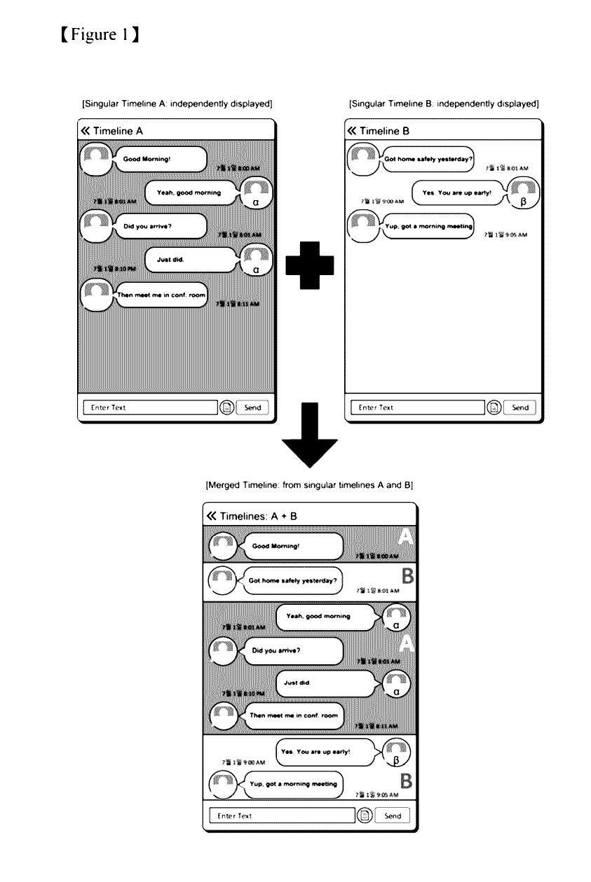

FIG. 1 is a diagram illustrating an example of changing to a merged timeline user interface according to an embodiment of the present invention.

In the present invention, a singular timeline denotes a timeline that constructs or organizes content data within a singular scope or a single context according to a time order, and may have a conventional timeline form. In detail, the singular timeline may denote a graphical user interface that provides data or a collection/set of data objects that form the timeline and contain time information.

In the present invention, a merged timeline denotes a timeline that is generated by merging two or more timelines—a singular timeline or a another merged timeline. In detail, the merged timeline denotes a timeline which is constructed from and contains data objects that are present and contained in any of those timelines that were incorporated in the merge.

In this case, each of the data objects included in the merged timeline may include information about an original singular timeline (what singular timeline the data object originated from) that was included and in corporated in to the merged timeline, and moreover, each of singular timelines included in the merged timeline is not altered.

For example, in the related art, like singular timelines A and B illustrated in an upper portion of FIG. 1, singular timelines are separately provided, and for this reason, it is required for a user to separately access the singular timelines. However, according to the present invention, like a merged timeline illustrated in a lower portion of FIG. 1, a user may simultaneously access and intuitively understand a plurality of timelines.

In the present invention, a content item object (or a content item) denotes a data object that composes or makes up the singular timeline or the merged time line, and may include detailed content and time information thereof.

In the present invention, a merge-target timeline (timeline to merge) denotes any timeline which can be merged into and included in the merged timeline, and more specifically, denotes a singular timeline selected to be merged or singular timelines contained within another merged timeline selected to be merged (or merged timeline as a whole).

In the present invention, a timeline display area denotes a graphical user interface that is configured to provide a timeline in a designated region of a display device.

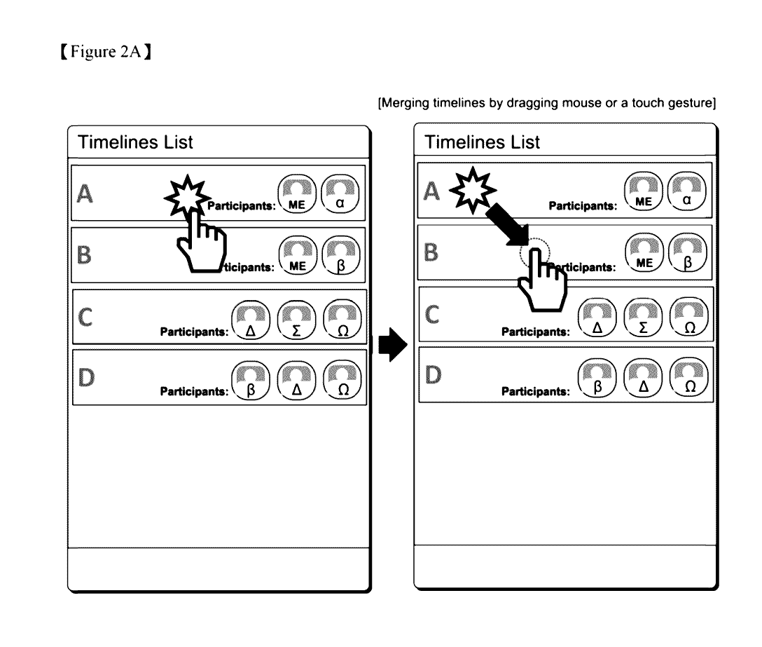

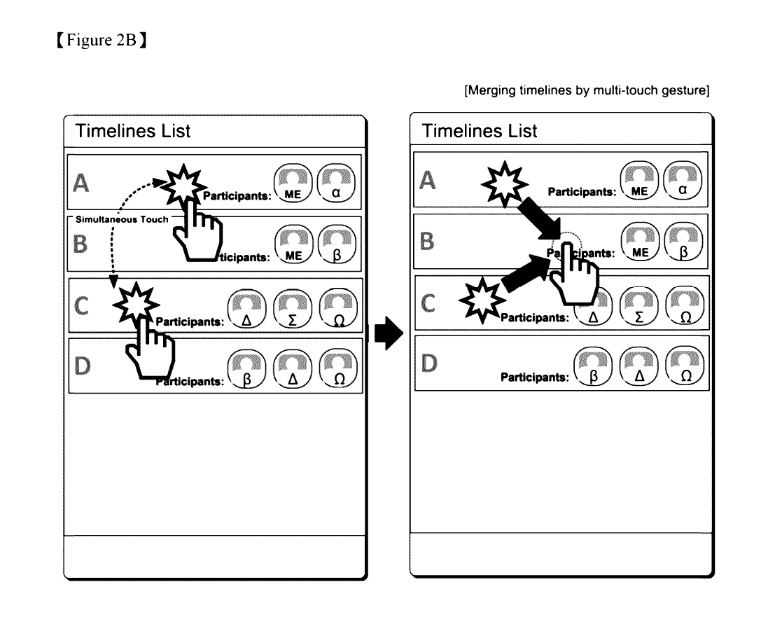

FIGS. 2A and 2B are diagrams describing an example of timeline-merging gesture based on a mouse or a touch. An apparatus having a touch sensitive surface may recognize a selection gesture to issue a command to merge timelines.

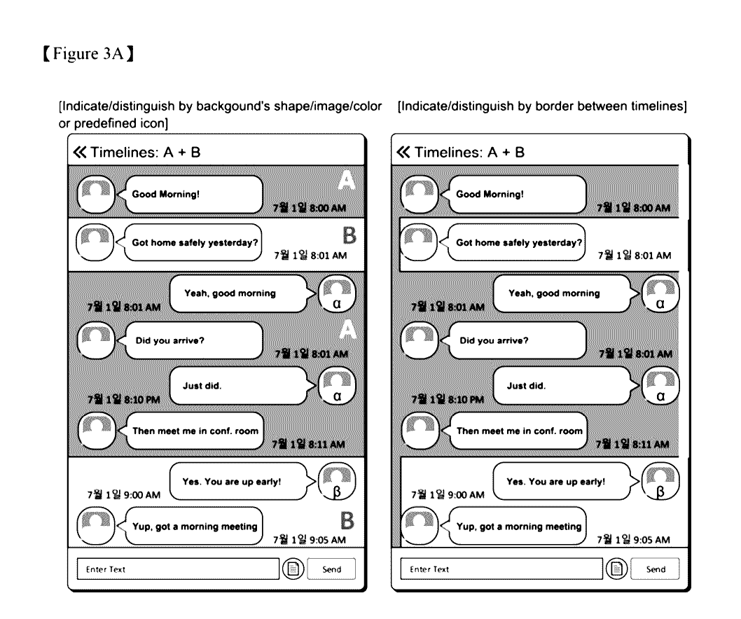

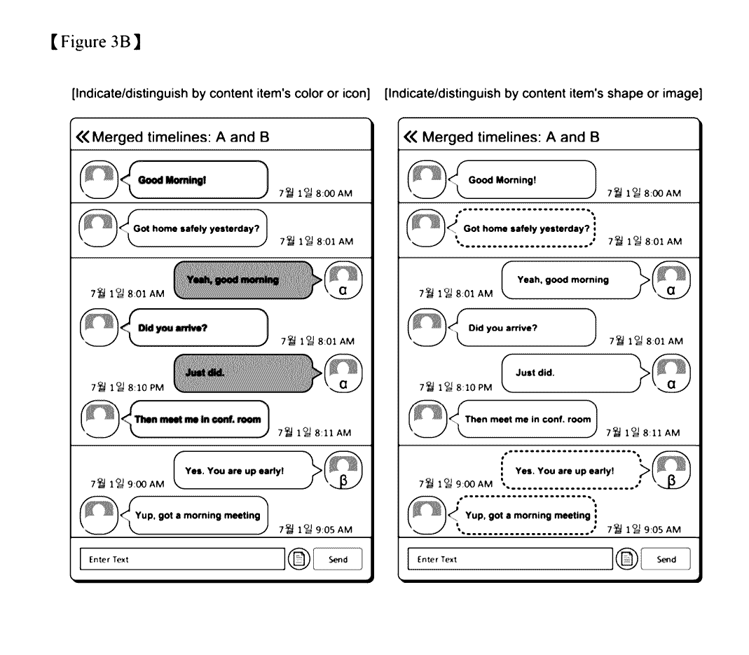

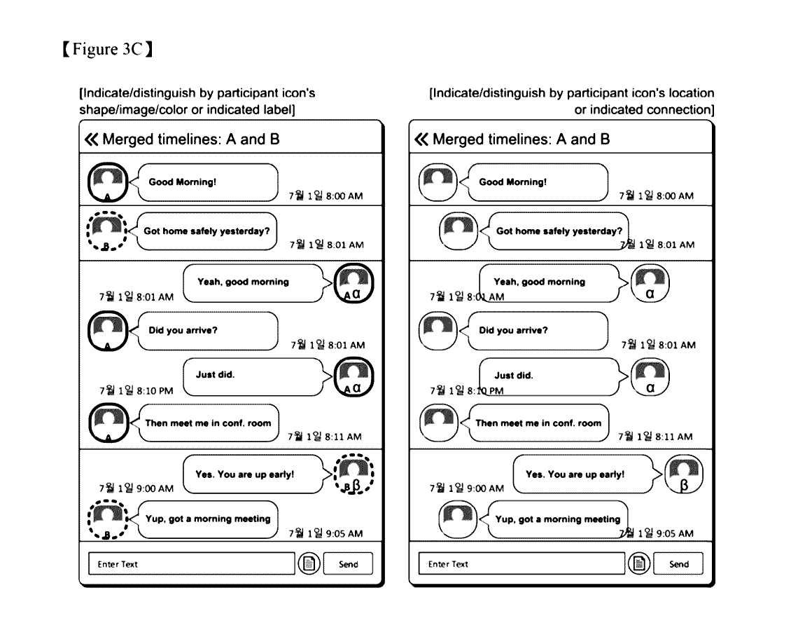

FIGS. 3A to 3C are diagrams illustrating an example of indication feature between merged singular timelines (singular timelines within a merged timeline) according to an embodiment of the present invention. An intuitively identifiable indication may be displayed through various components which include the shape, image, color, or a designated icon indication of a content item object, the shape, image, color, or a designated icon indication of a timeline background, and the shape, image, color, label, or position of a participant icon, which may be provided to a merged timeline user interface.

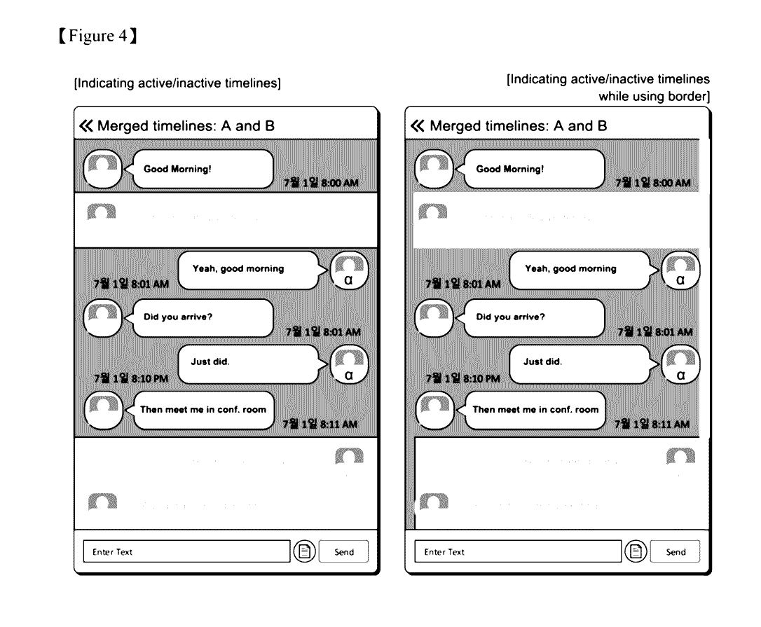

FIG. 4 is a diagram illustrating an example of “activation/deactivation indication feature” in a merged timeline according to an embodiment of the present invention.

In the present invention, activation/deactivation denotes a state of a singular timeline included in a merged timeline. In detail, when one timeline is selected, the selected timeline may be selected as a target of content input, and a user interface may display that the selected timeline has been activated or may display that an unselected timeline has been deactivated.

In the present invention, a timeline participant (or a participant) denotes another user which participates in a certain timeline or transmits/shares a certain content object.

In the present invention, a content input area denotes a graphical user interface which is provided within the timeline display area for inputting content to a timeline, wherein the timeline display area is configured to display and provide one or more timelines in a designated region of a display device.

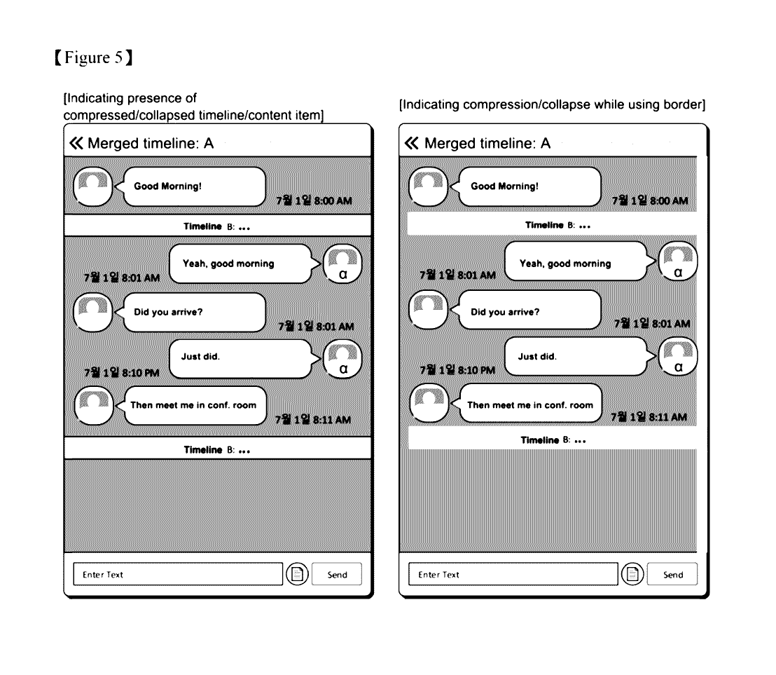

FIG. 5 is a diagram illustrating an example of an abbreviated timeline/object indicator according to an embodiment of the present invention.

In the present invention, an abbreviated timeline/object indicator is an element of the timeline display area, and denotes indicating the presence of omitted details instead of displaying details of one or more timelines or content item objects which are selected as an unnecessary to display by a user while providing a timeline.

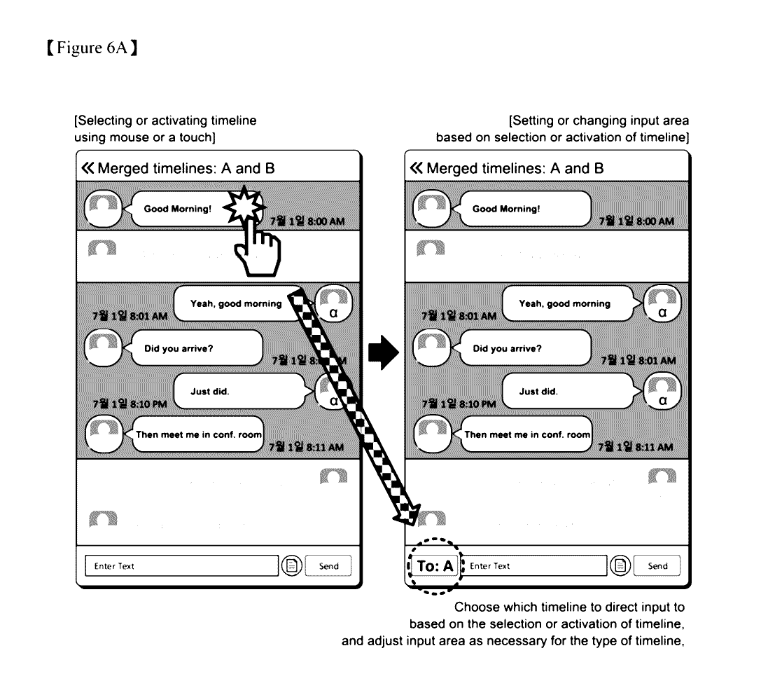

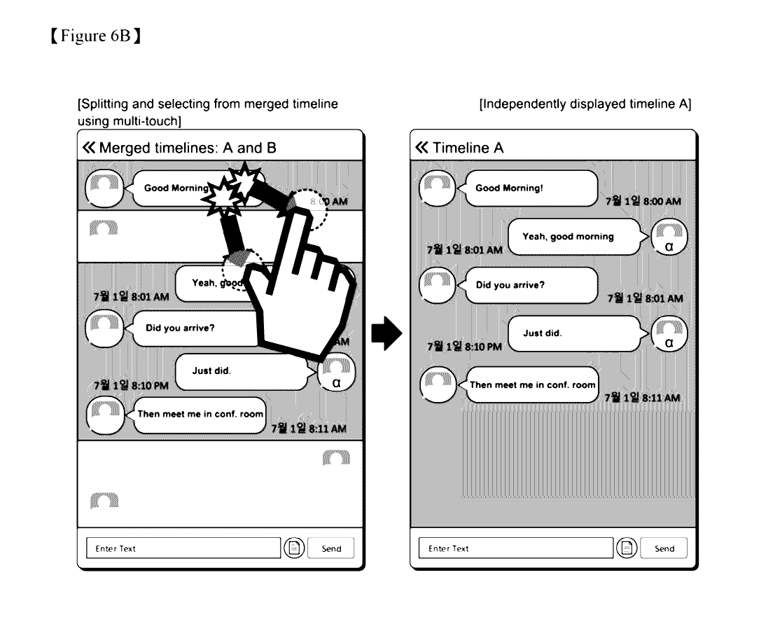

FIGS. 6A and 6B are diagrams illustrating an example of an activation of a timeline and changing content input area based on a touch input contacts of one, two or more according to an embodiment of the present invention. In an apparatus which has a touch sensitive surface or is connected to the touch sensitive surface, by using an intuitive touch gesture, a user may easily select or activate a timeline, or may conveniently alter or divide a merged timeline.

In the present invention, a related timeline denotes a timeline that holds a relationship with or relevance to a selected timeline or a content item object, and in detail, denotes a timeline that holds a common participant information as the selected timeline or a content item object, or a timeline that share any other common characteristic or attribute selected through a selection gesture.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A method performed on an apparatus which includes or is connected to a display device, the method comprising:
merging two or more merge-target timelines to generate a new merged timeline (merged/consolidated timeline), wherein each merge-target timeline is a singular timeline or a separate merged timeline containing a singular timeline, and the singular timeline includes zero content item object or one or more content item objects and time information for the one or more content item objects, and zero piece of participant information or one or more pieces of participant information; and
displaying the new merged timeline on the display device,
wherein the generating of the new merged timeline comprises:
dividing or converting all merged timelines, included in the merge-target timelines, into or to singular timelines;
correcting or adjusting a reference time for all singular timelines included in the merge-target timelines;
assigning a time order among each of content item objects included in the merge-target timelines; and
generating a new merged timeline by assigning information about the corresponding singular timeline to each content item objects included in the merge-target timelines and combining them into a new timeline.

2. The method of claim 1, wherein the content item object comprises transmission activity information—activity information about transmission, opening access, or sharing of various messages or content data.

3. The method of claim 1, wherein the content item object comprises online posting information—information about content or posting including a blog and a web page.

4. The method of claim 1, wherein the content item object comprises text data.

5. The method of claim 1, wherein the content item object comprises binary data—including content in the form of audio, video, picture, or file.

6. The method of claim 1, wherein the content item object comprises streaming content or streamed data.

7. The method of claim 1, wherein
the apparatus further comprises a touch sensitive surface,
the method further comprises selecting the merge-target timelines, and
the selecting of the merge-target timelines comprises:
simultaneously displaying the two or more merge-able (merge-target) timelines on the display device;
detecting one or more contacts, corresponding to positions of the merge-able (merge-target) timelines, from the touch sensitive surface;
recognizing a selection gesture in response to the number of the detected contacts, a start position, a contact point movement, and an end position; and
selecting a merge-target timeline to merge in response to the recognition of the selection gesture.

8. The method of claim 7, wherein the recognition of the selection gesture comprises, when the number of the detected contacts is one and the contact point moves so that there are timelines respectively corresponding to the start position and the end position of the movement, recognizing the selection gesture to select the timelines as merge-target timelines.

9. The method of claim 7, wherein the recognition of the selection gesture comprises, when the number of the detected contacts is two or more, there are timelines respectively corresponding to all contact start positions, and the contact points move so that a distance between contact points is reduced, recognizing the selection gesture to select the timelines as merge-target timelines.

10. The method of claim 7, wherein the touch sensitive surface is a touch pad.

11. The method of claim 7, wherein the contact is a finger contact.

12. The method of claim 7, wherein the contact is a stylus contact.

13. A graphical user interface in an apparatus which includes or is connected to a display device, the graphical user interface comprising:
a merged timeline area configured to provide a merged timeline in a designated region of the display device,
wherein
two or more merge-target timelines—a singular timeline or a separate merged timeline containing a singular timeline—are merged to provide the merged timeline composed of the content item objects using the apparatus, and
providing the merged timeline comprises:
providing the content item objects contained in the merged timeline in the common merged timeline area according to a time order,
wherein
the content item object comprises one or more of content data, transmission activity information, and posting information, and
the content item object displays an indication feature corresponding to the encompassing singular timeline including the content item object.

14. The graphical user interface of claim 13, wherein the timeline indication feature comprises a shape, image, color, or icon of each of the content item objects or a shape, image, color, or icon of a background of each of the content item objects.

15. The graphical user interface of claim 13, wherein the timeline indication feature comprises a border between content item objects included in different singular timelines.

16. The graphical user interface of claim 13, wherein
the content item object further comprises a participant icon, and
the participant icon comprises information related to a participant which has transmitted or posted the corresponding content item object.

17. The graphical user interface of claim 16, wherein the timeline indication feature comprises a shape, image, color, or label of the participant icon.

18. The graphical user interface of claim 16, wherein the timeline indication feature comprises a position of the participant icon in the merged timeline area or an indicated connection of the participant icon.

19. The graphical user interface of claim 13, wherein
the merged timeline are a further comprises “activation/deactivation indication feature” about a timeline
wherein the “activation/deactivation indication feature” denotes an active timeline either by displaying a selected singular timeline as “activated” or by displaying all other non-selected timelines as “deactivated”, and
the “activation/deactivation indication feature” is a shape, image, or color of the content item object.

20. The graphical user interface of claim 19, wherein
a designated region of the display device further comprises “content input area”, and the “content input area” comprises an element that inputs, transmits, or posts content data to the active singular timeline.

21. The graphical user interface of claim 20, wherein the “content input area” comprises an element that is changed according to the kind of active singular timeline.

22. The graphical user interface of claim 13, wherein
the merged timeline area further comprises “abbreviated timeline/object indicator”
wherein the “abbreviated timeline/object indicator” replaces and is displayed instead of one or more content item objects corresponding to a singular timeline according to a setting of the apparatus.

23. The graphical user interface of claim 22, wherein the timeline indication feature comprises a shape, image, or color of the “abbreviated timeline/object indicator” or a shape, image, or color of the content item object.

24. The graphical user interface of claim 22, wherein the timeline indication feature comprises a border between content item objects included in different singular timelines, between “abbreviated timeline/object indicators” included in different singular timelines, or between the content item object and “abbreviated timeline/object indicator” included in different singular timelines.

25. A method performed on an apparatus which includes or is connected to a touch sensitive surface and a display device, the method comprising:
displaying a merged timeline, generated by merging two or more merge-target timelines, in a designated merged timeline area of the display device; and
changing a state of the merged timeline,
wherein the changing of the state comprises:
detecting one or more contacts, corresponding to a position in the merged timeline area, from the touch sensitive surface;
recognizing a state change gesture in response to the number of the detected contacts, a start position, a contact point movement, and an end position; and
changing the merged timeline in response to the recognition of the state change gesture.

26. The method of claim 25, wherein the recognition of the state change gesture comprises, when the number of the detected contacts is one and there is a content item object corresponding to the start position without the contact point being moved, selecting and activating a singular timeline which includes the content item object and deactivating all other timelines.

27. The method of claim 25, wherein the recognition of the state change gesture comprises, when the number of the detected contacts is two or more and a distance between contact points increases according to the contact point being moved, closing the graphical user interface corresponding to the merged timeline, and navigating to a singular timeline which was previously selected and active.

28. A method performed on an apparatus which includes or is connected to a display device, the method comprising:
displaying one or more timelines on the display device, wherein each of the one or more timelines is a singular timeline or a merged timeline and includes zero content item object or one or more content item objects, time information of the one or more content item objects, and zero piece of participant information or one or more pieces of participant information; and
searching for a related timeline associated with the one or more timelines,
wherein the searching for the related timeline comprises:
selecting a criterion of searching for the related timeline;
conducting a search for the related timeline; and
displaying a result of the search for the related timeline.

29. The method of claim 28, wherein
the selecting of the criterion comprises selecting the criterion, based on participant information included in the one or more timelines or participant information corresponding to a specific content item object included in the one or more timelines, and
the conducting of the search for the related timeline comprises searching for another timeline including the participant.

30. The method of claim 28, wherein
the apparatus further comprises a touch sensitive surface, and
the selecting of the criterion comprises:
detecting one or more contacts, corresponding to positions of the one or more timelines, from the touch sensitive surface;
recognizing a selection gesture in response to the number of the detected contacts, a start position, a contact point movement, and an end position; and
selecting the criterion of the search for the related timeline in response to the recognition of the selection gesture.

31. A graphical user interface in an apparatus which includes or is connected to a display device, the graphical user interface comprising:
a timeline area configured to provide a timeline in a designated region of the display device,
wherein
the timeline is a singular timeline or a merged timeline, and
the timeline provides one or more content item objects included in the timeline to the timeline area according to a time order using the apparatus,
wherein
the content item object comprises one or more of content data, transmission activity information, and posting information, and
the content item object displays zero participant icon or one or more participant icons.

32. The graphical user interface of claim 31, wherein another timeline including a participant is searched for by clicking on a corresponding participant icon or through a menu displayed by the click, wherein a result of the search is provided as a related timeline.
